(19) United States
(12) Patent Application Publication
(10) Pub. No.: US 2026/0111562 A1
(43) Pub. Date: Apr. 23, 2026

(54) IDENTITY UNIFICATION

(71) Applicant: Proofpoint, Inc., Sunnyvale, CA (US)

(72) Inventors: Bar Maor, Ramat Gan (IL); Hila Rachel Chen, Herzliya (IL)

(21) Appl. No.: 18/922,361

(22) Filed: Oct. 21, 2024

(51) Int. Cl. G06F 21/57

(52) U.S. Cl. CPC G06F 21/577; G06F 2221/034

(57) ABSTRACT

A method for identity unification in an organization network, including correlating activity across disparate cloud-based and on-premises identity access and management platforms, including identifying, across the multiple cloud-based and on-premises identity access and management platforms, shared unique identifiers between identities, identifying, across the multiple cloud-based and on-premises identity access and management platforms, prefixes or suffixes within usernames based on naming conventions, parsing configuration data, to match users with their corresponding roles across the multiple cloud-based and on-premises identity access and management platforms, and discovering, across the multiple cloud-based and on-premises identity access and management platforms, cross-referenced sessions and profiles residing on a device that represent the same person.

### TECHNICAL FIELD OF THE INVENTION

The present invention relates to organization network security and risk assessment.

### BACKGROUND OF THE INVENTION

Within the complex landscape of contemporary information technology (IT) infrastructures, organizations often rely on a hybrid approach, employing a combination of cloud-based and on-premises solutions. This leads to a fragmented identity landscape, where a single user possesses numerous identity instances spread across various applications and platforms.

### SUMMARY OF THE INVENTION

In accordance with embodiments of the present invention, identity unification is a process that addresses the challenge of consolidating disparate identities into a singular comprehensive entity. This process involves aggregation of user data from diverse sources, encompassing Active Directory (AD), cloud applications, and Software as a Service (Saas) applications. Through this data consolidation, a holistic user profile is constructed encompassing details such as usernames, group affiliations, permissions and even login activity. A unified view unlocks a multitude of security advantages, facilitating a more strategic approach to threat management.

Identity unification empowers a more robust risk assessment strategy. By consolidating identities, potential security vulnerabilities become readily apparent. Identity unification enables identification of misconfigurations within user accounts, detection of overly permissive access privileges, and analysis of anomalous login behaviors across all platforms. Consequently, a more comprehensive understanding of a user's overall security posture is achieved.

There is thus provided in accordance with an embodiment of the present application a method for identity unification in an organization network, including correlating activity across disparate cloud-based and on-premises identity access and management platforms, including identifying, across the multiple cloud-based and on-premises identity access and management platforms, shared unique identifiers between identities, identifying, across the multiple cloud-based and on-premises identity access and management platforms, prefixes or suffixes within usernames based on naming conventions, parsing configuration data, to match users with their corresponding roles across the multiple cloud-based and on-premises identity access and management platforms, and discovering, across the multiple cloud-based and on-premises identity access and management platforms, cross-referenced sessions and profiles residing on a device that represent the same person.

There is additionally provided in accordance with an embodiment of the present invention a system for identity unification in an organization network, including an attribute matcher identifying, across multiple cloud-based and on-premises identity access and management platforms, shared unique identifiers between identities, a username parser identifying, across the multiple cloud-based and on-premises identity access and management platforms, prefixes or suffixes within usernames based on naming conventions, a role matcher parsing configuration data, to match users with their corresponding roles across the multiple cloud-based and on-premises identity access and management platforms, and a session analyzer discovering, across the multiple cloud-based and on-premises identity access and management platforms, cross-referenced sessions and profiles residing on a device that represent the same person.

### BRIEF DESCRIPTION OF THE DRAWINGS

Such features and advantages of the invention will become clearer upon reading the following description, given only as a non-limiting example, and made with reference to the enclosed drawings, wherein:

FIG. 1 is a screen shot of a dashboard for identity unification, according to an embodiment of the present invention;

FIG. 2 is a simplified diagram showing identity unification, according to an embodiment of the present invention;

FIG. 3 is a simplified diagram of a system for identity unification, according to an embodiment of the present invention; and

FIG. 4 is a simplified flowchart of a method for identity unification, according to an embodiment of the present invention.

The following definitions are employed throughout the specification.

ACTIVE DIRECTORY—Active Directory (AD) is a directory service developed by Microsoft for Windows domain networks. Windows Server operating systems include AD as a set of processes and services. Originally, only centralized domain management used Active Directory. However, it ultimately became an umbrella title for various directory-based identity-related services. A domain controller is a server running the AD Domain Service role. It authenticates and authorizes all users and computers in a Windows domain-type network, assigning and enforcing security policies for all computers and installing or updating software. For example, when a user logs into a computer part of a Windows domain, Active Directory checks the submitted username and password and determines whether the user is a system administrator or a non-admin user. Furthermore, it allows the management and storage of information, provides authentication and authorization mechanisms, and establishes a framework to deploy other related services. Active Directory uses Lightweight Directory Access Protocol (LDAP) versions 2 and 3, Microsoft's version of Kerberos, and DNS.

IDENTITY—Identity refers to the information utilized by computer systems to represent external entities, including a person, organization, application, or device. When used to describe an individual, the identity encompasses a person's compiled information and plays a crucial role in automating access to computer-based services, verifying identity online, and enabling computers to mediate relationships between entities (https://en.wikipedia.org/).

IDENTITY ACCESS AND MANAGEMENT PLATFORM—A network manager including inter alia Microsoft Active Directory, Azure Active Directory, Amazon Web services Identity and Access Management (AWS IAM), and Okta Customer Identity Cloud.

### DETAILED DESCRIPTION

Conventional security solutions are generally limited to isolated events within specific platforms. Identity unification transcends this limitation, offering a comprehensive perspective. By correlating activity across various disparate systems, identity unification enables detection of suspicious patterns that would otherwise go unseen, such as situations where a user's credentials are leveraged to gain unauthorized access to devices or applications.

In the event of a cyberattack, lateral movement represents a significant threat. Hackers may attempt to compromise low-privileged accounts to gain access to more critical systems within a network. Identity unification plays a crucial role in mitigating this risk. By establishing connections between user accounts and machine accounts across different platforms, identity unification facilitates discovering potential pathways for lateral movement. Identity unification enables proactive measures to be taken, thereby thwarting such attempts.

Identity unification leverages a multi-faceted approach to consolidate user data from various sources. The following is a breakdown of methods employed.

Matching attributes: This method prioritizes identification of attributes that are shared unique identifiers between identities. Common examples include objectGUID, email address or another attribute that definitively links separate entities. This method also accounts for variations in these attributes. E.g., in Microsoft Azure AD users created through Azure AD sync possess an attribute named ‘mS-DS-ConsistencyGuid’, which is essentially a base64 encoded version of the corresponding AD user attribute ‘objectGUID’. The unique identifiers in Active Directory are a list of object attributes, such as email, UPN, SAMAccountName. Those values are cross-referenced for identities from different identity stores—each identity store and its unique identifiers.

Strong user naming conventions: Certain user naming conventions denote privileged accounts used for administrative purposes. This method leverages this by identifying well-known industry-standard prefixes or suffixes within usernames. E.g., the prefix ‘X_’ is commonly used to designate a high-privilege, personal user account. When such naming conventions are identified, the corresponding identities are incorporated into the unified user profile.

Examples of naming conventions for privileged users:

x-tsmith / tsmith-x / x_tsmith / ...
da-tsmith / tsmith-da / ...
sa-tsmith / tsmith-sa / ...

These names are in conjunction to the naming convention that the org uses. For example—a person named Tommy Smith may be named tsmith, tommys, t_smith.

Application configuration parsing: This method extracts valuable insights from configuration settings employed by specific applications or identity providers, including configurations related to synchronizing entities between platforms. For instance, an organization might utilize Okta, as an identity provider, with a Security Assertion Markup Language (SAML) configuration file to synchronize identities and roles between Amazon Web Services (AWS) and AD. By parsing such configuration data, this method effectively matches users to their corresponding roles across different platforms.

Some applications, such as Okta, return the origin of the user using the ‘Provider’ attribute. When pulling Okta users from the API, a synced user will have the following data:

```
{
  “id”: “111-222-333”,
  ...
  },
  “profile”: {
    “firstName”: “Tommy”,
    “lastName”: “Smith”,
    “login”: “tsmith@corp.com”,
    “email”: “tsmith@corp.com”
  },
    “provider”: {
      “type”: “FEDERATION / IMPORT”,
      “name”: “ACTIVE_DIRECTORY”
    }
  }
}
```

Session-based identification: This method uses multiple sessions to a common computer to unify different identities. By cross-referencing sessions and profiles residing on a device, connections between identities which represent the same person are discovered.

By cross-referencing logins and existing sessions of accounts, accounts are unified with better precision. For example: both users tsmith@corp.com, and x_tsmith@corp.com log in to the same workstation, and have active sessions on it. This is one of several ways to lower false-positive ratios and improve precision.

By employing these methods in conjunction, identity unification achieves a comprehensive unification of identities, enabling a holistic view of user activity and access privileges across an entire IT infrastructure. Identity unification empowers organizations to proactively address cross-platform security threats and fortify their overall security posture.

Identity unification aggregates multiple identity instances of the same user from different identity providers, applications and platforms into one consolidated object. Identity unification is used to provide assessments on different identities in each platform, such as:
risk factors to find misconfigurations;
permissions on privileged entities in each platform to find escalation paths;
real-time detection of anomaly behavior; and
stored credentials on machine accounts that are related to the same user, to find possible lateral movement paths.

Identity unification enables understanding, assessing and mitigating cross-platform threats instead of singular events.

Different identities are aggregated according to the following logic.
1. Matching attributes—if two identities share a unique identifier, e.g., objectGUID, email address, or another attribute, they are joined based on these matching attributes, including variations of those attributes. E.g., in Microsoft Azure AD users created from Azure AD sync have an attribute ‘mS-DS-ConsistencyGuid’ which is a base64 of the matching AD user attribute ‘objectGuid’.
2. Strong users naming conventions—If a user has more privileged identities that he uses to perform administrative actions, they are aggregated to the unified profile as well. Well-known prefixes/suffixes in the industry are used to find these users. E.g., ‘X_’ is a common prefix to represent a strong, personal user.
3. Applications configuration—Whenever possible, configurations that certain applications or identity providers keep to sync entities from one platform to the other, are parsed. E.g., configuring identity sync between AWS and Active Directory may be done via Okta, as identity provider, using a SAML configuration file to match each user to his roles.

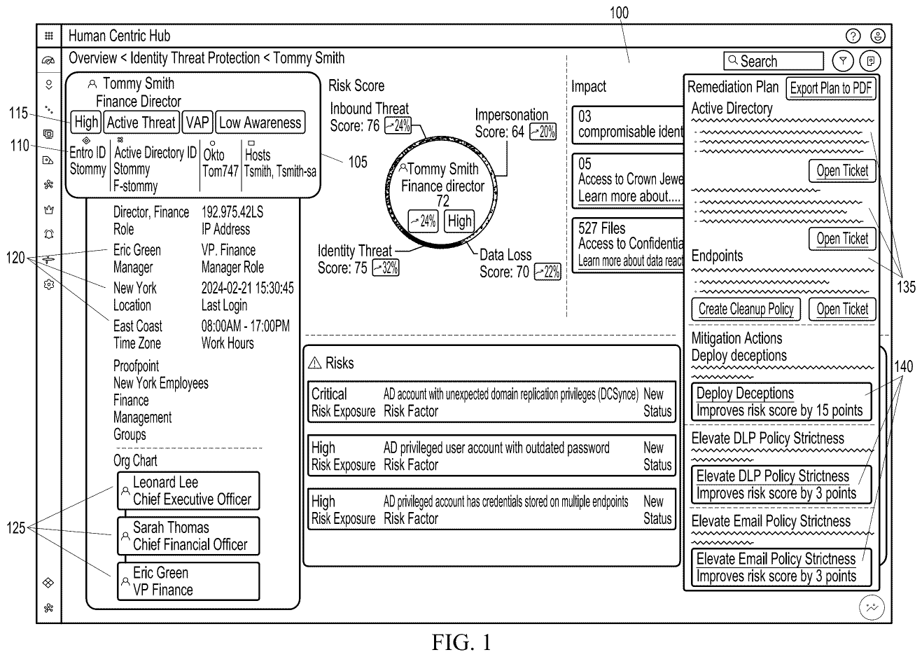

Reference is made to FIG. 1, which is a screen shot of a dashboard 100 for identity unification, according to an embodiment of the present invention. Shown in FIG. 1 is a profile 105 of a user, Tommy Smith, who is Finance Director of an organization, having multiple identities 110, including Entra ID “$tommy”, Active Directory iD “F-stommy”, Okta ID “tom747”, and host IDs “Tsmith” and “Tsmith-sa”. FIG. 1 also shows various security-based tags 115 regarding this user; namely, “High”-a high risk, “Active Threat”—a currently active threat, “Very Attacked Person (VAP)” and “Low Awareness”—Tommy Smith is not aware of good network safety practice. FIG. 1 also shows attributes 120 of this user; namely, manager, Eric Green, his location, his time zone, his last login, and his work hours. FIG. 1 also shows an organization chart 125 from Tommy Smith's manager, Eric Green, to the CEO.

FIG. 1 also shows network risk exposures 130 labelled “critical” and “high”. Network risk exposures 130 include “AD account with unexpected domain replication privileges (DCSync)”, “AD privileged user account with outdated password”, and “AD privileged account with credentials stored on multiple endpoints”. FIG. 1 also shows remediations plans 135 for network risks 130, and mitigation actions 140.

Finally, FIG. 1 includes a risk score 145 of seventy-two and impacts 150 of the risks; namely, 3 compromisable identities, 5 accesses to crown jewels, and 527 files with access to confidential information. Risk scores 190 are described in Applicant's co-pending application U.S. Ser. No. 18/412,542 entitled Risk Factors for an Organization Network.

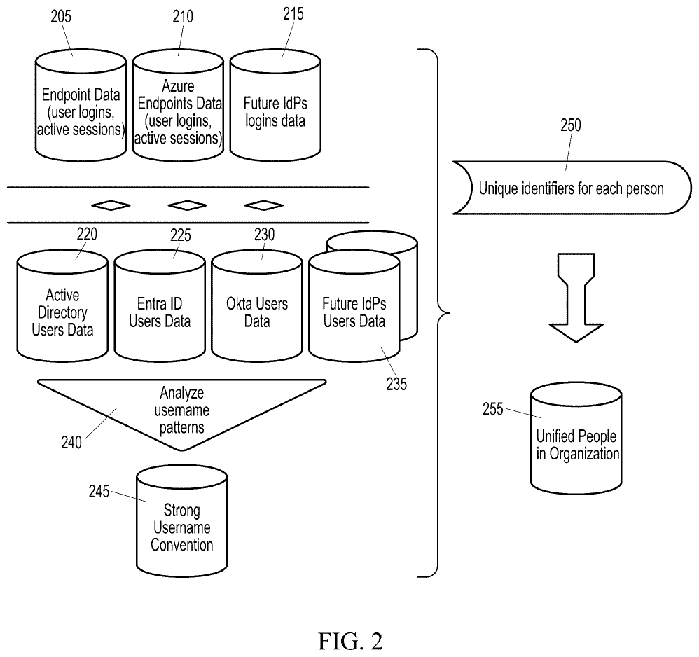

Reference is made to FIG. 2, which is a simplified diagram of a method for identity unification, according to an embodiment of the present invention. FIG. 2 shows how user identities across various platforms are unified. FIG. 2 shows various data stores including network endpoint data 205 including user logins and active sessions; namely, Azure endpoint data 210 including user logins and active sessions, future identity provider login data 215, Active Directory user data 220, Entra ID user data 225, Okta user data 230, and future identity provider user data 235. An analyzer 240 analyzes username patterns as described hereinabove, based on a data store 245 of strong username conventions, to generate unique identifiers 250 for each person, which are saved in a data store 255 of unique people in an organization.

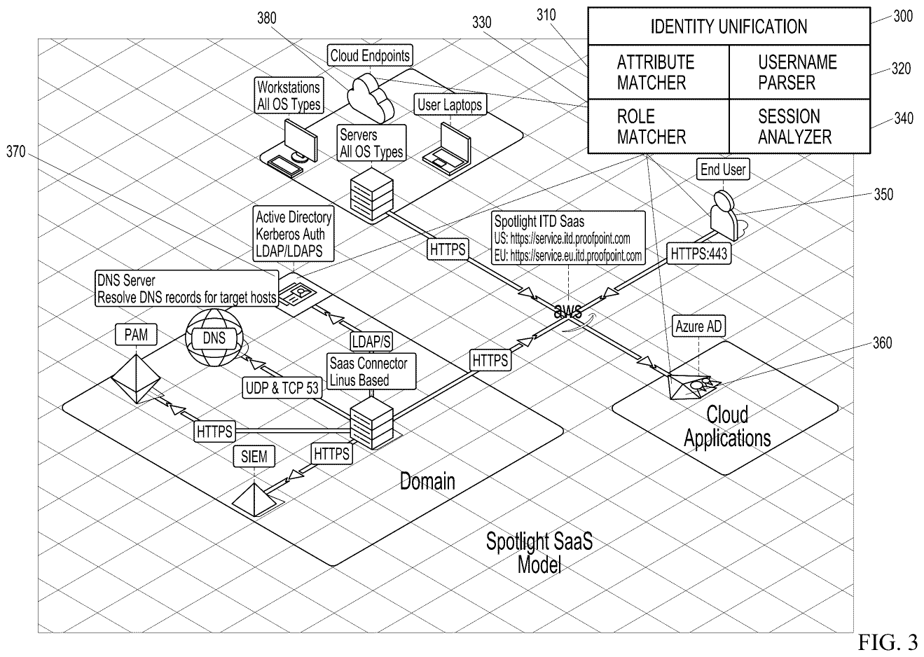

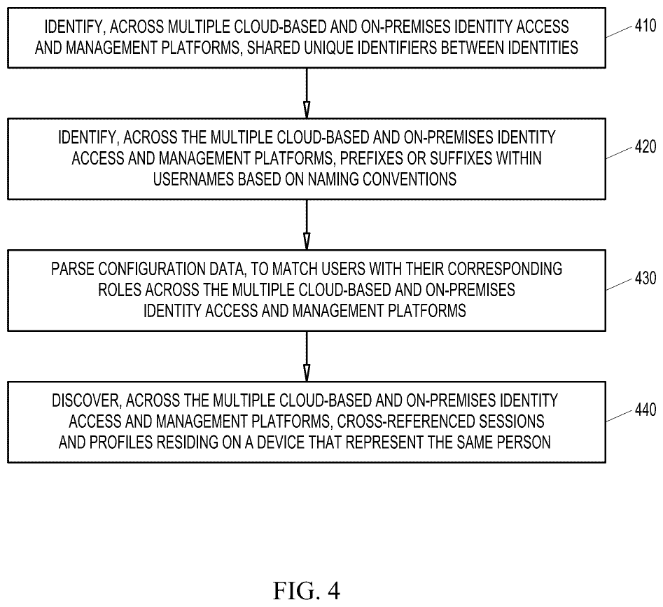

Reference is made to FIG. 3, which is a simplified diagram of a system for identity unification, according to an embodiment of the present invention. FIG. 3 shows an identification unification module 300 that includes four components; namely, an attribute matcher 310, a username parser 320, a role matcher 330, and a session analyzer 340. Operation of these components is described with reference to FIG. 4 hereinbelow. Identity unification module 300 receives user data from end users 350, Azure Active Directory 360, Microsoft Active Directory 370, and cloud endpoints 380, and unifies the various data stores in FIG. 2.

Reference is made to FIG. 4, which is a simplified diagram of a flowchart of a method for identity unification, according to an embodiment of the present invention. The method of FIG. 4 receives as input data stores from various identity access and management platforms, such as data stores 350, 360, 370 and 380 of FIG. 3, and generates as output a data store of merged identities, the merged identities having identities that have been matched across the various platforms.

At operation 410, attribute matcher 310 identifies, across the multiple cloud-based and on-premises identity access and management platforms, shared unique identifiers between identities. At operation 420, username parser 320 parses configuration data, to match users with their corresponding roles across the multiple cloud-based and on-premises identity access and management platforms. At operation 430, role matcher 330 parses configuration data, to match users with their corresponding roles across the multiple cloud-based and on-premises identity access and management platforms. At operation 440, session analyzer 340 discovers, across the multiple cloud-based and on-premises identity access and management platforms, cross-referenced sessions and profiles residing on a device that represent the same person.

Operations 410, 420, 430 and 440 may be applied in any order.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

1. A method for identity unification in an organization network, comprising correlating activity across disparate cloud-based and on-premises identity access and management platforms, comprising:
identifying, across the multiple cloud-based and on-premises identity access and management platforms, shared unique identifiers between identities;
identifying, across the multiple cloud-based and on-premises identity access and management platforms, prefixes or suffixes within usernames based on naming conventions;
parsing configuration data, to match users with their corresponding roles across the multiple cloud-based and on-premises identity access and management platforms; and
discovering, across the multiple cloud-based and on-premises identity access and management platforms, cross-referenced sessions and profiles residing on a device that represent the same person.

2. The method of claim 1 wherein the identity access and management platforms comprise active directory (AD) applications and software as a service (Saas) applications.

3. The method of claim 1 wherein the unique identifiers comprise an object globally unique identifier (objectGUID), or an email address.

4. The method of claim 1, wherein said discovering comprises discovering cross-referenced logins and existing sessions of accounts.

5. A system for identity unification in an organization network, comprising:
an attribute matcher identifying, across multiple cloud-based and on-premises identity access and management platforms, shared unique identifiers between identities;
a username parser identifying, across the multiple cloud-based and on-premises identity access and management platforms, prefixes or suffixes within usernames based on naming conventions;
a role matcher parsing configuration data, to match users with their corresponding roles across the multiple cloud-based and on-premises identity access and management platforms; and
a session analyzer discovering, across the multiple cloud-based and on-premises identity access and management platforms, cross-referenced sessions and profiles residing on a device that represent the same person.
